(19) United States
(12) Patent Application Publication
(10) Pub. No.: US 2006/0013981 A1
(43) Pub. Date: Jan. 19, 2006

(54) Polytetrahydrofuran-Based Coating for Capillary Microextraction

(75) Inventors: Abdul Malik, Tampa, FL (US); Abuzar Kabir, Tampa, FL (US)

Correspondence Address: SMITH & HOPEN PA, 15950 BAY VISTA DRIVE, SUITE 220, CLEARWATER, FL, 33760, US

(73) Assignee: UNIVERSITY OF SOUTH FLORIDA, Tampa, FL (US)

(21) Appl. No.: 11/161,004

(22) Filed: Jul. 19, 2005

Related U.S. Application Data
(60) Provisional application No. 60/521,900, filed on Jul. 19, 2004.

(51) Int. Cl. B29D 22/00

(52) U.S. Cl. 428/36.91; 427/226; 427/230

(57) ABSTRACT

A sol-gel poly-THF coating was developed for high-performance capillary microextraction to facilitate ultra-trace analysis of polar and nonpolar organic compounds. Parts per quadrillion level detection limits were achieved using Poly-THF coated microextraction capillaries in conjunction with GC-FID. Sol-gel Poly-THF coatings showed extraordinarily high sorption efficiency for both polar and nonpolar compounds, and proved to be highly effective in providing simultaneous extraction of nonpolar, moderately polar, and highly polar analytes from aqueous media. Sol-gel poly-THF coated microextraction capillaries showed excellent thermal and solvent stability, making them very suitable for hyphenation with both gas-phase and liquid-phase separation techniques, including GC, HPLC, and CEC. In CME-HPLC and CME-CEC hyphenations, sol-gel poly-THF coated microextraction capillaries have the potential to provide new levels of detection sensitivity in liquid-phase trace analysis, and to extend the analytical scope of CME to thermally labile-, high molecular weight-, and other types of compounds that are not amenable to GC.

### CROSS REFERENCE TO RELATED APPLICATION

This application claims the benefit of priority under 35 U.S.C. §11 9(e) of U.S. Provisional Application Ser. No. 60/521,900, filed Jul. 19, 2004, which is incorporated herein by reference.

### FIELD OF INVENTION

The present invention relates to analytical separation and extraction technology. More specifically, the present invention relates to separation and extraction columns for use in separating, extracting and/or concentrating analytes in a sample.

BACKGROUND OF INVENTION

Solid-phase microextraction (SPME) is an excellent solventless alternative to the traditional sample preparation techniques like liquid-liquid extraction (LLE), Soxhlet extraction, solid-phase extraction (SPE), etc. It is a simple, sensitive, time-efficient, cost-effective, reliable, easy-to-automate, and portable sample preparation technique. In SPME, analyte enrichment is accomplished by using a sorbent coating in two different formats: (a) conventional fiber-based format and (b) the more recently developed “in-tube” format. In its conventional format, SPME uses a sorbent coating on the external surface of a fused silica fiber (typically 100-200 μm in diameter) covering a short segment at one of the ends. In the in-tube format, the sorbent coating is applied to the inner surface of a capillary. SPME completely eliminates of the use of organic solvents in sample preparation, and effectively integrates a number of critically important analytical steps such as sampling, extraction, preconcentration, and sample introduction for instrumental analysis. Thanks to these positive attributes, SPME has experienced an explosive growth over the last decade. Despite rapid advancements in the area of SPME applications, a number of important problems still remain to be solved. First, existing SPME coatings are designed to extract either polar or nonpolar analytes from a given matrix. For example, being a nonpolar stationary phase, polydimethylsiloxane (PDMS) shows excellent selectivity towards nonpolar analytes. The polar polyacrylate coating, on the other hand, demonstrates excellent selectivity towards polar compounds. Such an approach is not very convenient for samples where both polar and non-polar contaminants are present and both need to be analyzed. For such applications, it is important to have a sorbent that can extract both polar and nonpolar compounds with high extraction sensitivity needed for trace analysis. Second, in conventional SPME only a short length of the fiber is coated with sorbent. The short length of the coated segment on the SPME fiber translates into low sorbent loading which in turn leads to low sample capacity. This imposes a significant limitation on the sensitivity of the classical fiber-based SPME. Improving sensitivity is still a major challenge in SPME research. This is particularly important for analyzing ultra-trace contaminants that are present in the environment. One possible way of improving extraction sensitivity in SPME is by increasing the coating thickness. However, equilibration time rapidly increases with the increase in coating thickness because of the dynamic diffusion-controlled nature of the extraction process. As a consequence, both extraction and subsequent desorption processes become slower, resulting in longer total analysis time. Moreover, immobilization of thicker coating on fused silica surface is difficult to achieve by conventional approaches indicating to the necessity of an alternative approach to effective immobilization of thick coatings. Third, low thermal and solvent stability of SPME coatings represents a major drawback of conventional SPME technology, and is a direct consequence of the poor quality of sorbent immobilization. With a very few exceptions, SPME fibers have been coated by mere physical deposition of the stationary phase. The absence of chemical bonding of the sorbent coating to the fused silica surface is considered to be the main reason for low thermal and solvent stability of SPME fibers. Low thermal stability of thick coatings forces one to use low desorption temperatures to preserve coating integrity, which in turn, leads to incomplete sample desorption and sample carryover problems. Besides, low solvent stability of the coating poses a significant obstacle to reliable hyphenation of in-tube SPME with liquid-phase separation techniques (e.g., H PLC) that employ organic or organo-aqueous mobile phases. It is evident that future advancements in SPME would greatly depend on new developments in the areas of sorbent chemistry and coating technology that will allow preparation of chemically immobilized coatings from advanced material systems providing desired selectivity and performance in SPME.

One possible approach to address most of the problems described above is to use sol-gel technology to create sorbent coatings. Sol-gel chemistry provides a simple and convenient pathway leading to the synthesis of advanced material systems that can be used to prepare surface coatings. In the context of fused silica fiber/capillary-based SPME, major advantages offered by sol-gel technology are as follows: (1) it combines surface treatment, deactivation, coating, and stationary phase immobilization into a single-step procedure making the whole SPME fiber/capillary manufacturing process very efficient and cost-effective; (2) it creates chemical bonds between the fused silica surface and the created sorbent coating; (3) it provides surface-coatings with high operational stability ensuring reproducible performance of the sorbent coating under operation conditions involving high temperature and/or organic solvents, and thereby it expands the SPME application range toward both higher-boiling as well as thermally labile analytes; (4) it provides the possibility to combine organic and inorganic material properties in extraction sorbents providing tunable selectivity; (5) it offers the opportunity to create sorbent coatings with a porous structure which significantly increases the surface area of the extracting phase and provides acceptable stationary phase loading and sample capacity using thinner coatings.

A number of shortcomings inherent in conventional SPME originate from the design and physical construction of the fiber and the syringe-like SPME device. These include susceptibility of fiber to breakage during coating or operation, mechanical damage of the coating due to scraping, and operational uncertainties due to needle bending. In-tube SPME, also termed capillary microextraction (CME), is practically free from these inherent format-related shortcomings of conventional SPME. It uses a fused silica capillary (generally a small piece of GC column) with a stationary phase coating on the inner surface to perform extraction. The protective polyimide coating outside the capillary remains intact and provides reliable protection against breakage. Moreover, this format provides a simple, easy, and convenient way to couple SPME to high-performance liquid chromatography. Despite numerous advantageous features, in-tube SPME still has several inherent shortcomings that originate mainly from the deficiency of the coating technique used to prepare the extraction capillary. Conventional static coating technique, commonly employed to prepare GC capillary columns (short segments of which are used for in-tube SPME), is not suitable for generating thick coatings necessary for enhanced extraction sensitivity in SPME. Besides, in general, a conventionally prepared coating is not chemically bonded to the fused silica capillary surface. As a consequence, such coatings exhibit low thermal and solvent stability. Recently, sol-gel capillary microextraction (CME) has been proposed to address the above-mentioned problems through in situ creation of surface-bonded coatings via sol-gel technology, which is suitable for creating both thick and thin coatings on the capillary inner walls.

In both conventional SPME and CME, the sorbent coating plays a critically important role in the extraction process. To date, several types of sorbent coatings have been developed and used for extraction. These coatings can be broadly divided into two major types: (1) single-phase- and (2) composite coatings. Single-phase SPME coatings include polydimethylsiloxane (PDMS), Polyacrylate, Carbopack, polyimide, polypyrrole, and molecularly imprinted materials. Among the composite coatings are Carbowaxidivinylbenzene (CW/DVB), polydimethylsiloxane/divinylbenzene (PDMS/DVB), polydimethylsiloxane/Carboxane (PDMS/Carboxane), and Carbowax/templated resin (CWITPR).

In recent years, sol-gel SPME coatings have drawn wide attention due to their inherent advantageous features and performance superiority over traditional coatings (both non-bonded and cross-linked types). Sol-gel PDMS coatings possess significantly higher thermal stability (>360° C.) than their conventional counterparts for which the upper temperature limit generally remains within 200-270° C. High thermal and solvent stability have been demonstrated for other sol-gel stationary phases: sol-gel PEG (320° C.), sol-gel crown ethers (340° C.), sol-gel hydroxyfullerene (360° C.), sol-gel polymethylphenylvinylsiloxane (350° C.).

Sol-gel PEG coating has been recommended for polar analytes. Sol-gel crown ether demonstrated higher extraction efficiencies for aromatic amines compared to CW/DVB fiber. Gbatu et al. described the preparation of sol-gel octyl coatings for SPME-HPLC analysis of organometalic compounds from aqueous solutions. Compared with the commercial SPME coatings, a hydroxyfullerene-based sol-gel coating showed higher sensitivity, faster mass transfer rate for aromatic compounds and possessed molecular planarity recognition capability for polychiorinated biphenyls (PCB5). Yang et al. prepared sol-gel poly (methylphenylvinylsiloxane) (PMPVS) coating using sol-gel technology that provided very high extraction efficiency for aromatic compounds.

Poly-THF (also called polytetramethylene oxide, PMTO) is a hydroxy-terminated polar material that has been used as an organic component to synthesize organic-inorganic hybrid materials (H. Goda, C. W. Frank, Chem. Mater. 13 (2001) 2783; A. Fidalgo, L. M. Ilharco, J. Non-Crystalline Solids 283 (2001) 144; C. S. Betrabet, G. L. Wilkes, Chem. Mater. 7 (1995) 535; T. Higuchi, K. Kurumada, S. Nagamine, A. W. Lothongkum, M. Tanigaki, J. Materials Science 35 (2000) 3237; A. Fidalgo, T. G. Nunes, L. M. liharco, J. Sol-Ge/Sci. Technol. 19 (2000) 403 and A. Fidalgo, L. Ilharco, J. Sol-Gel Sci. Technol. 13 (1998) 433). Sol-gel poly-THF has been used as bioactive bone repairing material (M. Kamitakahara, M. Kawashita, N. Miyata, T. Kokubo, T. Nakamura, Biomaterials 24 (2003) 1357), and as a proton conducting solid polymer electrolyte that might allow the operation of high temperature fuel cells (I. Honma, O. Nishikawa, T. Sugimoto, S. Nomura, H. Nakajima, Fuel Cells 2 (2002) 52). Little work has been devoted to explore the potential of the sol-gel poly-THF material for use as an extraction medium in analytical chemistry. In the present work, we describe a sol-gel chemistry-based approach to in situ creating poly-THF based hybrid organic-inorganic stationary phase coatings on the inner walls of fused silica capillaries and demonstrate the possibility of using such coatings to extract parts per trillion (ppt) and parts per quadrillion level concentrations of both polar and nonpolar analytes from aqueous sample matrices.

### SUMMARY OF INVENTION

One aspect of the present invention is directed at methods of making a sol-gel polytetrahydrofuran-based coatings. The method includes the steps of mixing two or more suitable sol-gel precursors to form a sol-gel solution, hydrolyzing the sol-gel precursors to form hydrolyzed products, polycondensating the hydrolyzed precursors to form a sol-gel network wherein the sol-gel network forms an evolving organic-inorganic network and surface bonding the sol-gel network on a portion of the capillary inner walls to form a surface bonded sol-gel coating on the capillary walls. The first of the two or more sol-gel precursors in the mixing step is polytetrahydrofuran. In certain embodiments of the present invention a second of the two or more sol-gel precursors is methyltrimethoxysilane. Additionally, in certain other embodiments of the method of making a sol-gel polytetrahydrofuran-based coatings, the method will include the step of deactiviating residual silanol groups on the sol-gel coating with a deactivating agent. Deactivating reagents used in the deactivating step can include hydrosilanes, polymethylhydrosiloxianes, polymethylphenyl hydrosiloxanes and polymethylcyanopropyl hydrosiloxanes. In certain advantageous embodiments the deactivating reagent is hexamethyidisilazane. It is also found to be advantageous in certain embodiments to perform the deactivating step at elevated temperatures during column conditioning. The mixing step can utilize trifluoroacetic acid as the catalyst. The mixing step can further include adding an additional catalyst selected from the group consisting of acids, bases or fluorides. Finally, in certain embodiments it is found advantageous to perform the hydrolyzing and polycondensating steps within the sol-gel solution in proximity to the inner walls of a capillary tube.

The present invention also provides for a microextraction capillary for the preconcentration of trace analytes in a sample. The microextraction capillary has a tube structure and an inner surface. The inner surface is further characterized by the presence of a sol-gel polytetrahydrofuran-based coating. The sol-gel polytetrahydrofuran-based coating forms the stationary phase for the microextraction of the analytes.

The microextraction capillary with the sol-gel polytetrahydrofuran-based coating can be made from two or more sol-gel precursors where the first of the two or more sol-gel precursors is polytetrahydrofuran. In certain embodiments of the present invention it is found advantageous to utilize methyltrimethoxysilane as

a second of the two or more sol-gel precursors. In certain embodiments of the present invention it is also found advantageous to have the inner surface of the capillary composed of fused silica. It is further found advantageous to chemically bonded to the sol-gel polytetrahydrofuran-based coating to the fused-silica inner surface of the capillary. The microextraction capillary can include an outer surface having a protective coating to prevent against breakage of the capillary. The protective coating can be a polyimide protective coating. A further advantageous embodiment of the present invention provides a sol-gel polytetrahydrofuran-based coating that is at least about 250 μm in thickness.

The present invention further provides for a method of making a polytetrahydrofuran-based sol-gel coated capillary for microextraction of analytes in a sample medium. The method includes the steps of preparing a sol solution comprising polytetrahyrdofuran (poly-THF), processing the sol solution to form a sol-gel extraction medium, filling a capillary with the sol-gel extraction medium wherein the sol-gel extraction medium chemically binds to the inner walls of the capillary to form a polytetrahydrofuran-based sol-gel coated capillary and purging the capillary of unbound sol-gel extraction medium. In certain advantageous embodiments the method will include methyltrimethoxysilane as a sol-gel precursor in the sol solution.

It is also found advantageous in certain embodiments to have the capillary remain filled with the sol-gel extraction media for at least about 30 minutes to facilitate the formation of a surface bonded sol-gel coating before the unbound sol-gel extraction medium is purged. It is particularly advantageous in certain embodiments to allow the capillary to remain filled with the sol-gel extraction media for about 60 minutes to facilitate the formation of a surface bonded sol-gel coating before the unbound sol-gel extraction medium is purged. The step of purging the capillary of unbound sol-gel extraction medium can be performed by applying helium pressure of about 50 psi for at least about 30 minutes. Lastly, the method of making a polytetrahydrofuran-based sol-gel coated capillary for microextraction of analytes in a sample medium can advantageous include the step of conditioning the polytetrahydrofuran-based sol-gel coated capillary in an oven using temperature-programmed heating wherein the heat increments upward from about 40° C. to about 320° C. at an increment of about 1° C./minute followed by a holding at about 320° C. for about 5 hours.

### BRIEF DESCRIPTION OF THE DRAWINGS

For a fuller understanding of the nature and objects of the invention, reference should be made to the following detailed description, taken in connection with the accompanying drawings, in which:

FIG. 1. Schematic of a gravity-fed sample dispensing unit used in capillary microextraction with a sol-gel poly-THF coated capillary.

FIG. 2. IR spectra of pure polytetrahydrofuran (top), sol solution having all ingredients except polytetrahydrofuran (middle), sol-gel polytetrahydrofuran coating (bottom).

FIG. 3. Scanning electron microscopic image of a 320 mm i.d. sol-gel poly-THF coated fused silica capillary used in capillary microextraction. (A) Illustrating uniform coating thickness on the inner surface of the fused silica capillary, magnification: 15,000×. (B) Illustrating porous network of the poly-THF coating obtained by sol-gel coating technology, magnification: 10,000×.

FIG. 4. Illustration of the extraction kinetics of nonpolar (fluoranthene and phenanthrene) and moderately polar (heptanophenone and dodecanal) compounds extracted on a 12.5 cm×320 mm i.d. sol-gel poly-THF coated capillary using 1 0 ppb aqueous solution of each analyte in a mixture. Extraction kinetic of highly polar compound pentachlorophenol was obtained separately on a 12.5 cm×320 mm i.d. sol-gel poly-THF coated capillary using 50 ppb aqueous solution. Extraction conditions: Extraction time, 10-50 min. GC analysis conditions: 10 m×250 mm i.d. sol-gel PDMS column; splitless injection; injector temperature, initial 30° C., final 300° C., at a rate of 100° C./min; GC oven temperature programmed from 30° C. (hold for 5 min) to 300° C. at a rate of 20° C./min; Helium carrier gas; FID temperature 350° C.

FIG. 5. Capillary Microextraction-GC analysis of PAHs (20 ppb each) using sol-gel poly-THF coated capillary. Extraction time, 30 min. GC analysis conditions: 10 m×320 mm i.d. sol-gel PDMS column; splitless injection; injector temperature, initial 30° C., final 300° C., at a rate of 100° C./min; GC oven temperature programmed from 30° C. (hold for 5 min) to 300° C. at a rate of 15° C./min; Helium carrier gas; FID temperature 350° C. Peaks: (1) Acenaphthene, (2) Fluorene, (3) Phenanthrene, (4) Fluoranthene, and (5) Pyrene.

FIG. 6. Capillary Microextraction-GC analysis of Aldehydes at 20 ppb concentration using poly-THF coated capillary. Extraction time, 30 min. GC analysis conditions: 10 m×320 mm i.d. sol-gel PDMS column; splitless injection; injector temperature, initial 30° C., final 300° C., at a rate of 100° C./min; GC oven temperature programmed from 30° C. (hold for 5 min) to 300° C. at a rate of 20° C./min; Helium carrier gas; FID temperature 350° C. Peaks: (1) n-Nonanal (2) Decanal, (3) Undecanal and (4) Dodecanal.

FIG. 7. Capillary Microextraction-GC analysis of Ketones at (20 ppb) using poly-THF coated capillary. Extraction time, 30 min. GC analysis conditions: 10 m×250 mm i.d. sol-gel PDMS column; splitless injection; injector temperature, initial 30° C., final 300° C., at a rate of 100° C./min; GC oven temperature programmed from 30° C. (hold for 5 min) to 300° C. at a rate of 20° C./min; Helium carrier gas; FID temperature 350° C. Peaks: (1) Butyrophenone, (2) Valerophenone, (3) Hexanophenone, (4) Heptanophenone, and (5) Decanophenone.

FIG. 8. Capillary Microextraction-GC analysis of chlorophenols using poly-THF coated capillary. Extractions were carried out from a solution containing 2-chlorophenol (1 ppm); 2,4-dichlorophenol (50 ppb); 2,4,6-trichlorophenol (50 ppb); 4-chloro, 3-methylphenol (100 ppb); and pentachlorophenol (50 ppb). Extraction time, 30 min. GC analysis conditions: 10 m×250 mm i.d. sol-gel PDMS column; splitless injection; injector temperature, initial 30° C., final 300° C. at a rate of 100° C./min; GC oven temperature programmed from 30° C. (hold for 5 min) to 300° C. at a rate of 20° C./min; Helium carrier gas; FID temperature 350° C. Peaks: (1) 2-Chlorophenol, (2) 2,4-Dichlorophenol, (3) 2,4,6-Trichlorophenol, (4) 4-Chloro, 3-methylphenol, and (5) Pentachlorophenol.

FIG. 9. Capillary Microextraction-GC analysis of alcohols (100 ppb each) using poly-THF coated capillary. Extraction time, 30 min. GC analysis conditions: 10 m×250 mm i.d. sol-gel PEG column; splitless injection; injector temperature, initial 30° C., final 300° C. at a rate of 100° C./min; GC oven temperature programmed from 30° C. (hold for 5 min) to 280° C. at a rate of 20 C/min; Helium carrier gas; FID temperature 350° C. Peaks: (1) 1-Heptanol, (2)1-Octanol, (3)1-Nonanol, (4) 1-Decanol, (5) 1 -Undecanol, (6)1-Dodecanol, and (7)1-Tridecanol.

FIG. 10. Capillary Microextraction-GC analysis of a mixture of nonpolar, moderately polar and polar compounds using poly-THF coated capillary. Extractions were carried out from a solution containing 2-chlorophenol (1 ppm); 2,4,6-trichlorophenol (50 ppb); pentachlorophenol (50 ppb); valerophenone (10 ppb); hexanophenone (10 ppb); nonanal (10 ppb); decanal (10 ppb); fluoranthene (10 ppb); pyrene (10 ppb). Extraction time, 30 min. GC analysis conditions: 10 m×250 mm i.d. sol-gel PDMS column; split-splitless injection (desorption of analyte in splitless mode); injector temperature, initial 30° C., final 300° C. at a rate of 100° C./min; GC oven temperature programmed from 30° C. (hold for 5 min) to 300° C. at a rate of 15° C./min; Helium carrier gas; FID temperature 350° C. Peaks: (1) 2-Chlorophenol, (2) Nonanal, (3) Decanal, (4) 2,4,6-Trichlorophenol, (5) Valerophenone, (6) Hexanophenone, (7) Pentachlorophenol, (8) Fluoranthene, and (9) Pyrene.

FIG. 11. Illustration of a longitudinal, cross-section view of a capillary column having a bound sol-gel network.

FIG. 12. Illustration of surface-bonded sol-gel poly-THF network on the fused silica capillary inner walls.

### DETAILED DESCRIPTION OF THE INVENTION

Generally, the present invention provides a method and apparatus for preconcentrating trace analytes. Most generally, the method involves the step of preconcentrating polar and non-polar analytes through a sol-gel coating or monolithic bed. A sol-gel poly-THF coating was developed for high-performance capillary microextraction to facilitate ultra-trace analysis of polar and nonpolar organic compounds. Parts per quadrillion level detection limits were achieved using Poly-THF coated microextraction capillaries in conjunction with GC-FID. This represents the first application of a sol-gel poly-THF sorbent in analytical microextraction. Sol-gel Poly-THF coatings showed extraordinarily high sorption efficiency for both polar and nonpolar compounds, and proved to be highly effective in providing simultaneous extraction of nonpolar, moderately polar, and highly polar analytes from aqueous media. Sol-gel poly-THF coated microextraction capillaries showed excellent thermal and solvent stability, making them very suitable for hyphenation with both gas-phase and liquid-phase separation techniques, including GC, HPLC, and CEC. In CME-HPLC and CME-CEC hyphenations, sol-gel poly-THF coated microextraction capillaries have the potential to provide new levels of detection sensitivity in liquid-phase trace analysis, and to extend the analytical scope of CME to thermally labile-, high molecular weight-, and other types of compounds that are not amenable to GC. Further sensitivity enhancement should be possible through the use of monolithic microextraction capillaries with sol-gel poly-THF based hybrid organic-inorganic sorbents. This could open up new possibilities in ultra-trace analysis of organic pollutants in aqueous media.

The capillary column provides for a rapid and simple method for simultaneous deactivation, coating, and stationary phase immobilization. To achieve this goal, a sol-gel chemistry-based approach to column preparation is provided that is a viable alternative to conventional gas chromatography (hereinafter “GC”) column technology. The sol-gel column technology eliminates the major drawbacks of conventional column technology through chemical bonding of the sol-gel stationary phase molecules to an interfacial layer that evolves on the top of the original capillary surface. More specifically, the present invention provides for a sol-gel preconcentration column having improved thermal stability and higher efficiency.

The present invention has numerous applications and uses. Primarily, the present invention is useful in separation processes involving analytes including, but not limited, to polycyclic aromatic hydrocarbons (PAHs), alcohols, aldehydes, ketones, chlorophenols, and other analytes known to those of skill in the art. Accordingly, the present invention is useful in chemical, petrochemical, environmental, pharmaceutical applications, and other similar applications.

The present invention has various advantages over the prior art. The sol-gel chemistry-based approach to column technology provides a fast way of surface roughening, deactivation, coating, and stationary phase immobilization—all carried out in a single step. Unlike conventional column technology in which these procedures are carried out as individual, time-consuming, steps, the new technology can achieve all these just by filling a capillary with a sol solution of appropriate composition, and allowing it to stay inside the capillary for a controlled period, followed by inert gas purging and conditioning of the capillary. The new technology greatly simplifies the methodology for the preparation of high efficiency GC columns, and offers an opportunity to reduce the column preparation time at least by a factor of ten. Being simple in technical execution, the new technology is very suitable for automation and mass production. Columns prepared by the new technology provide significantly superior thermal stability due to direct chemical bonding of the stationary phase coating to the capillary walls. The sol-gel column technology has the potential to offer a viable alternative to existing methods for column preparation in analytical microseparation techniques.

The present invention has numerous embodiments, depending upon the desired application. As described below, the formation of the various embodiments are intended for use in capillary microextraction. However, due to the vast applicability of the present invention, the column and related methods thereof can be modified in various manners for use in other areas of analytical separation technologies. The principles of the present invention can also be used to form capillary columns for use in various applications associated with gas chromatography, liquid chromatography, capillary electrochromatography, supercritical fluid chromatography, and as sample preconcentrators, including fiber-based SPME, where a compound of interest is present in very small concentrations in a sample.

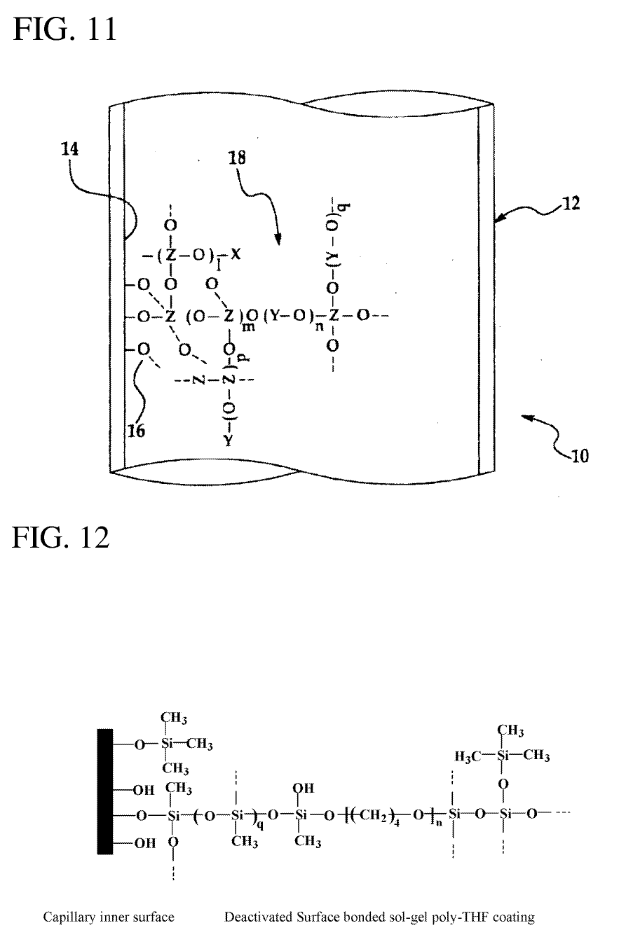

FIG. 11 presents a capillary column 10 including a tube structure 12 having inner walls 14 and a sol-gel substrate 16 coated on a portion of the inner walls 14 of the tube structure 12 to form a stationary phase coating 18 on the inner walls 14. The stationary phase coating 18 is created using at least one baseline stabilizing reagent and at least one surface deactivation reagent. The stationary phase coating 18 is bonded to the inner walls 14 of the tube structure 12. The surface-bonded sol-gel substrate 16 is applied to the inner walls 14 of the tube structure 12. An apparatus for use in applying the sol-gel substrate is taught in U.S. Patent Application Publication No. US 2004/0129141 A1, the contents of which is incorporated herein by reference.

The tube structure 12 of the capillary column 10 can be made of numerous materials including, but not limited to alumina, fused silica, glass, titania, zirconia, polymeric hollow fibers, and any other similar tubing materials known to those of skill in the art. Typically, fused silica is the most convenient material used. Sol-gel chemistry in analytical microseparations presents a universal approach to creating advanced material systems including those based on alumina, titania, and zirconia that have not been adequately evaluated in conventional separation column technology. Thus, the sol-gel chemistry-based column technology has the potential to effectively utilize advanced material properties to fill this gap.

Sol-gel chemistry is an elegant synthetic pathway to advanced materials that can be effectively utilized to create surface-bonded organic-inorganic hybrid coatings on the outer surface of conventional SPME fibers as well as on the inner walls of a capillary for use in CME (in-tube SPME). Additionally, sol-gel technology can be used for creating both thin and thick coatings employing a wide variety of sol-gel active organic ligands.

Polytetrahydrofuran (poly-THF) is a medium polarity polymer with terminal hydroxyl groups that can be utilized to bind this polymer to a sol-gel network via polycondensation reaction. It consists of tetramethylene oxide repeating units, and is synthesized through cationic ring opening polymerization of tetrahydrofuran using various initiators.

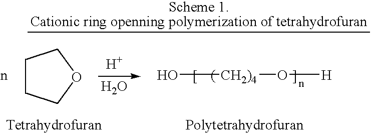

Table 1 lists the chemical ingredients used in this work to prepare the sol solution for creating a sol-gel poly-THF coated capillary.

TABLE 1

| Name | Function | Structure |
|---|---|---|
| Methyltrimethoxysilane (MTMOS) | Sol-gel precursor | 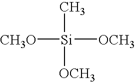 |
| Polytetrahydrofuran | Organic ligand | 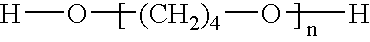 |
| Trifluoroacetic | Catalyst | CF₃COOH |
| acid/water 95:5 (v/v) | | |
| Methylene Chloride | Solvent | CH₂Cl₂ |
| Hexamethyldisilazane | Deactivating reagent | 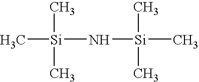 |

The in situ creation of a highly stable, deactivated sol-gel coating involved the following processes: (1) catalytic hydrolysis of the alkoxide precursors, (2) polycondensation of the hydrolyzed precursor with other sol-gel-active components of the sol solution, (3) chemical bonding of poly-THF to the evolving sol-gel network, (4) chemical anchoring of the evolving hybrid organic-inorganic polymer to the inner walls of the capillary, and (5) derivatization of residual silanol groups on the coating by HMDS.

In order to create the sol-gel poly-THF coating in situ, the sol solution was kept inside the capillary for 60 min to allow for the hydrolytic polycondensation reactions to take place in the sol solution located inside the capillary. In presence of the sol-gel catalyst (TFA), the sol-gel precursor (MTMOS) undergoes hydrolysis reaction. The hydrolysis products can then take part in polycondensation reactions in a variety of ways to create a three-dimensional sol-gel network. During this polycondensation process, the growing sol-gel network can chemically incorporate the poly-THF molecules resulting an organic-inorganic hybrid network structure. Fragments of this network located in close vicinity of the fused silica capillary walls have the opportunity to become chemically bonded to the capillary inner surface as a result of condensation reaction with the silanol groups on the capillary walls. This leads to the formation of a surface-bonded sol-gel coating on the inner walls of the capillary. HMDS, used in the coating solution, deactivates the residual silanol groups on the sorbent coating during the post-coating thermal conditioning of the capillary.

A simplified scheme of the surface-bonded sol-gel poly-THF network on the fused-silica capillary inner walls as found in an advantageous embodiment of the present invention is presented in scheme 2.

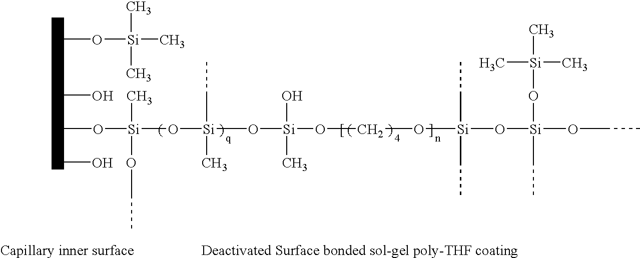

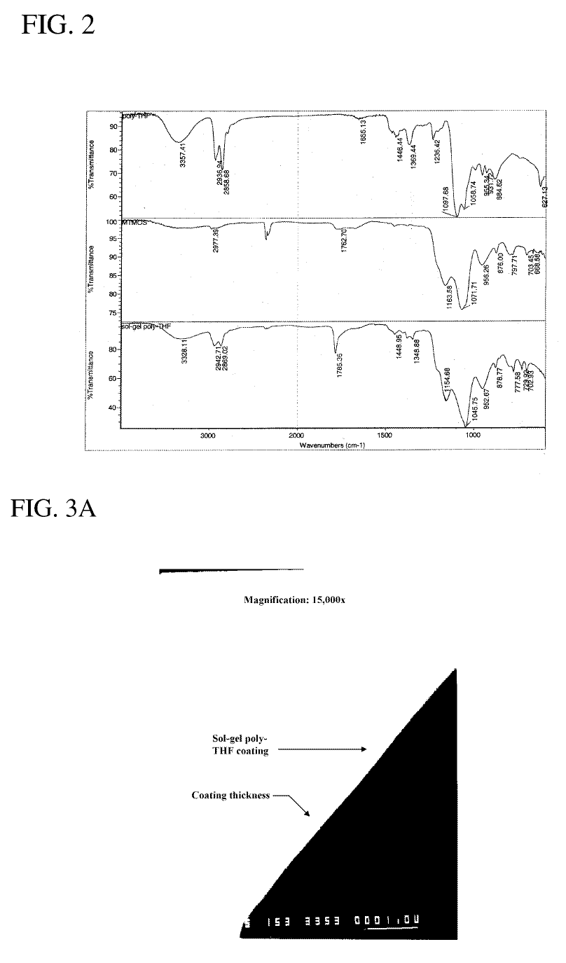

FIG. 2 shows three FTIR spectra representing pure poly-THF (top), sol solution having all ingredients except poly-THF (middle), sol-gel poly-THF sorbent (bottom). The bottom spectrum contains an IR band at 1045 cm⁻¹, which is characteristics of Si—O—C bonds and is indicative of the successful chemical incorporation of polytetrahydrofuran in the silica-based sol-gel network.

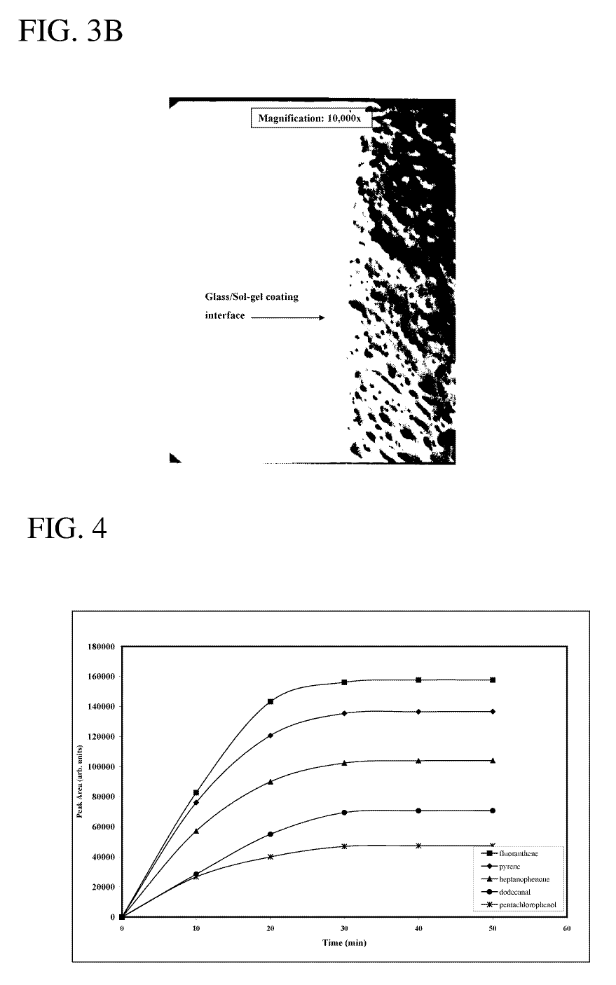

FIG. 3 represents scanning electron micrographs (SEMs) of a sol-gel poly-THF coated capillary at two different orientations using two different magnifications: 15,000× (3a) and 10,000× (3b) From FIG. 3a the coating thickness was estimated at 0.5 μm. As can be seen from the image, sol-gel poly-THF coating is remarkably uniform in thickness. FIG. 3b represents the surface view of the coating obtained at a magnification of 10,000×. It reveals the underlying porous structure of the sol-gel poly-THF coating. Due to the porous nature, the sol-gel poly-THF extraction media possesses enhanced surface area, an advantageous feature to achieve enhanced sample capacity. The porous structure also facilitates efficient mass transfer through the coating, which in turn, translates into reduced equilibrium time during extraction.

CME is a non-exhaustive extraction technique. Quantitation by CME is based on solute extraction equilibrium established between the sample solution and the coating. Therefore, the time required to reach the equilibrium is particularly important. FIG. 4 illustrates the CME kinetic profiles of two nonpolar analytes (fluoranthene and pyrene), two moderately polar analytes (heptanophenone and dodecanal) and a highly polar analyte (pentachlorophenol) extracted on a sol-gel poly-THF coated capillary. Extractions were carried out using aqueous solutions of fluoranthene (10 ppb), pyrene (10 ppb), dodecanal (20 ppb), heptanophenone (20 ppb), and pentachlorophenol (50 ppb). As can be seen, both nonpolar, moderately poloar, and highly polar compounds reached respective equilibria within 30 min. This is indicative of the fast diffusion in the sol-gel poly-THF coating. Based on these experimental results, further experiments in this work were carried out using a 30-min extraction time.

Sol-gel poly-THF coated capillaries were used to extract analytes of environmental, biomedical, and ecological importance, including polycyclic aromatic hydrocarbons (PAHs), aldehydes, ketones, alcohols, and phenols. The extracted compounds were further analyzed by GC. The CME-GC analysis data for PAHs, aldehydes, and ketones are presented in Table 2, and those for alcohols and phenols are provided in Table 3.

TABLE 2

| | | Peak area repeatability (n = 3) | | | | Retention | | |
|---|---|---|---|---|---|---|---|---|
| | | Capillary- to- | | | | time (t_{R}) | | |
| | | capillary | | Run- to- run | | repeatability | | |
| | | Mean | | Mean | | (n = 5) | | Detection |
| | | peak area | | peak area | | Mean | | Limits |
| Chemical Class | Name of the | (arbitrary | RSD | (arbitrary | RSD | t_{R} | RSD | S/N = 3 |
| of the Analyte | Analyte | unit) | (%) | unit) | (%) | (min) | % | (ppq) |
| Polyaromatic | Acenaphthene | 137139 | 2.13 | 125289 | 5.05 | 15.21 | 0.09 | 625 |
| | Fluorene | 118764 | 2.62 | 110767 | 3.01 | 16.01 | 0.10 | 460 |
| Hydrocarbons | Phenanthrene | 146853 | 4.49 | 139518 | 3.13 | 17.37 | 0.10 | 400 |
| | Fluoranthene | 144590 | 6.17 | 136260 | 2.92 | 19.08 | 0.08 | 260 |
| | Pyrene | 89573 | 6.45 | 94873 | 1.07 | 19.39 | 0.09 | 750 |
| Aldehydes | Nonanal | 80550 | 4.35 | 78583 | 2.19 | 10.98 | 0.09 | 1000 |
| | Decanal | 102377 | 4.01 | 98444 | 7.48 | 11.71 | 0.04 | 625 |
| | Undecanal | 76601 | 5.37 | 67730 | 5.38 | 12.41 | 0.07 | 750 |
| | Dodecanal | 61995 | 10.31 | 51594 | 6.77 | 13.05 | 0.06 | 940 |
| Ketones | Butyrophenone | 116887 | 3.48 | 110735 | 2.03 | 11.95 | 0.10 | 1000 |
| | Valerophenone | 121583 | 3.02 | 106301 | 3.09 | 12.66 | 0.10 | 460 |
| | Hexanophenone | 152281 | 3.43 | 120600 | 8.36 | 13.30 | 0.09 | 600 |
| | Heptanophenone | 158320 | 4.79 | 124831 | 5.10 | 13.92 | 0.10 | 340 |
| | Decanophenone | 113741 | 8.01 | 79475 | 5.75 | 15.55 | 0.09 | 1000 |

TABLE 3

| | | Peak area repeatability (n = 3) | | | | | | |
|---|---|---|---|---|---|---|---|---|
| | | Capillary- to- | | | | | | |
| | | capillary | | Run- to- run | | Retaintion time | | |
| | | Mean | | Mean | | (t_{R}) repeatability | | Detection |
| | | peak area | | peak area | | (n = 6) | | Limits |
| Chemical Class | Name of the | (arbitrary | RSD | (arbitrary | RSD | Mean tR | | S/N = 3 |
| of the Analyte | analyte | unit) | (%) | unit) | (%) | (min) | RSD % | (ppt) |
| Phenols | 2-Chlorophenol | 4531 | 8.74 | 7278 | 7.32 | 10.02 | 0.10 | 150 |
| | 2,4-Dichlorophenol | 8599 | 3.99 | 11297 | 5.63 | 11.37 | 0.10 | 85 |
| | 2,4,6- | 10272 | 7.02 | 13823 | 3.83 | 12.24 | 0.09 | 81 |
| | Trichlorophenol | | | | | | | |
| | 4-Chloro, 3- | 13731 | 4.50 | 16933 | 2.21 | 12.52 | 0.09 | 30 |
| | methylphenol | 28379 | 3.72 | 32551 | 4.10 | 14.80 | 0.10 | 18 |
| | Pentachlorophenol | | | | | | | |
| Alcohols | Heptanol | 33644 | 11.75 | 40576 | 6.78 | 9.32 | 0.16 | 13 |
| | Octanol | 69227 | 2.62 | 81241 | 2.21 | 10.01 | 0.15 | 5 |
| | Nonanol | 84151 | 1.21 | 97397 | 2.56 | 10.67 | 0.19 | 0.75 |
| | Decanol | 119187 | 4.67 | 136046 | 2.85 | 11.30 | 0.18 | 0.61 |
| | Undecanol | 156758 | 4.71 | 167255 | 3.85 | 11.90 | 0.10 | 0.59 |
| | Dodecanol | 140261 | 6.74 | 143091 | 4.34 | 12.48 | 0.20 | 1.15 |
| | Tridecanol | 187638 | 6.91 | 216896 | 4.69 | 13.02 | 0.16 | 1.15 |

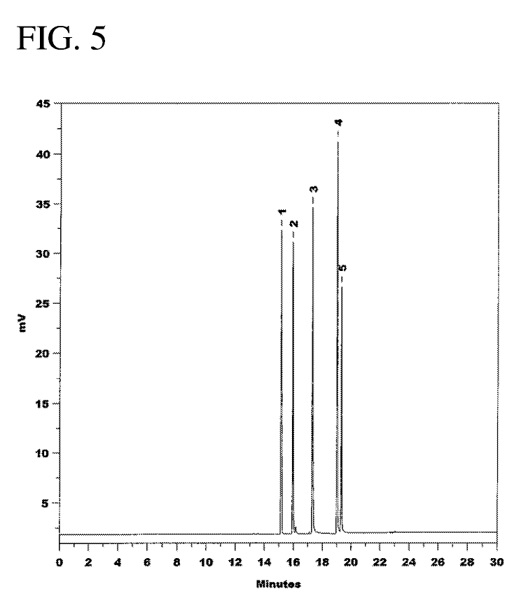

PAHs are ubiquitous environmental pollutants that present potential health hazards because of their toxic, mutagenic, and carcinogenic properties. Because of this, Environmental Protection Agency (EPA) has promulgated 16 unsubstituted PAHs in its list of 129 priority pollutants. FIG. 5 shows a gas chromatogram representing CME-GC analysis of 5 unsubstituted polyaromatic hydrocarbons from EPA priority list. They were extracted from an aqueous solution (each at 10 ppb) by capillary microextraction using a sol-gel poly-THF coated capillary. As can be seen from the data presented in Table 2, run-to-run and capillary-to-capillary repeatability in peak area obtained in CME-GC-FID experiments was quite satisfactory. For all PAHs, the RSD values were under 6%. Moreover, parts per quadrillion (ppq) level detection limits were obtained for PAHs in the CME-GC-FID using by sol-gel poly-THF microextraction capillaries. These detection limits are significantly lower than those reported by others via SPME-GC-FID (e.g., 260 ppt for pyrene) using 100 μm thick PDMS coated commercial SPME fiber.

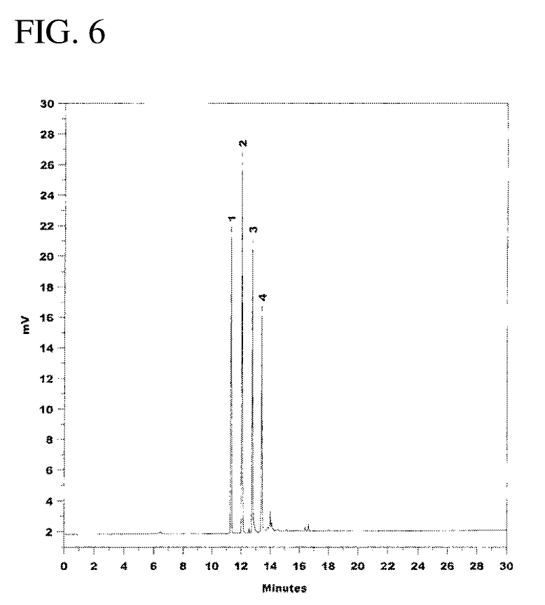

Aldehydes and ketones (carbonyl compounds) are of increasing concern due to their potential adverse health effects and environmental prevalence. Aldehydes and ketones can form in water by the photodegradation of dissolved natural organic matter. They may also form as disinfection by-products due to chemical reactions of chlorine and/or ozone (frequently used to disinfect water) with natural organic matter present in water. Many of these by-products have been shown to be carcinogens or carcinogen suspects. This is, in part, due to the high polarity and reactivity of carbonyl compounds in water matrices. FIG. 6 represents a gas chromatogram of a mixture of underivatized aldehydes that were extracted from an aqueous solution containing 20 ppb of each analyte.

The data presented in Table 2 indicate that a sol-gel poly-THF coated capillary can extract free aldehydes from aqueous media to provide a limit of detection (LOD) which is comparable with, or lower than that achieved through derivatization. For example, LOD for decanal has been reported as 200 ppt (in SPME-GC-ECD) on a 65 μm DVB-PDMS coating after derivatization with o-(2,3,4,5,6-pentafluorobenzyl) hydroxylamine hydrochloride (PFBHA) whereas in the present work a significantly lower detection limit (625 ppq) was achieved for the same analyte using a sol-gel poly-THF coated capillary in hyphenation with GC-FID, even though ECD often provides higher sensitivity than FID for oxygenated compounds. The same trend has also been observed for other analytes. It should be pointed out that derivatization of these analytes, especially when they are present in trace concentration, may complicate the analytical process, thus compromising quantitative accuracy.

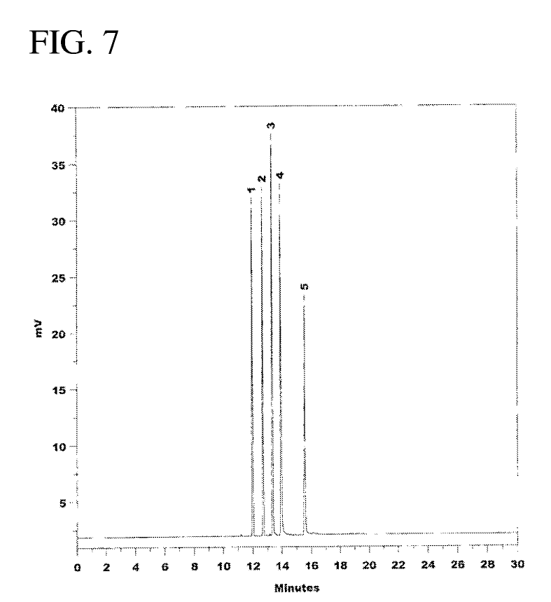

FIG. 7 represents a gas chromatogram of a mixture of 5 underivatized ketones (20 ppb each) extracted from an aqueous solution. Excellent peak shapes (FIG. 7) and run-to-run and capillary-to-capillary extraction reproducibility (Table 2) are indicative of preserved separation efficiency in CME-GC analysis and versatility of the sol-gel coating procedure used to prepare the extraction capillaries and the used GC column.

Chlorophenols (CPs) represent an important class of contaminants in environmental waters and soils due to their widespread use in industry, agriculture, and domestic purposes. Chlorophenols have been widely used as preservatives, pesticides, antiseptics, and disinfectants. They are also used in producing dyes, plastics and pharmaceuticals. In the environment, chlorophenols may also form as a result of hydrolysis, oxidation and microbiological degradation of chlorinated pesticides. Chlorine-treated drinking water is another source of chlorophenols. As a result, chlorophenols are often found in waters, soils, and sediments. Chlorophenols are highly toxic, poorly biodegradable, carcinogenic and recalcitrant. Owing to their carcinogenicity and considerable persistence, five of the chlorophenols (2-chlorophenol; 2,4-dichlorophenol; 2,4,6-trichlorophenol; 4-chloro-3-methylphenol and pentachlorophenol) have been classified as priority pollutants by the US EPA. Since chlorophenols are highly polar, it is quite difficult to extract them directly from polar aqueous media. Derivatization, pH adjustment, and/or salting-out are often used to facilitate the extraction. To reduce the analytical complexity due to derivatization, HPLC is frequently used for the analysis of phenolic compounds.

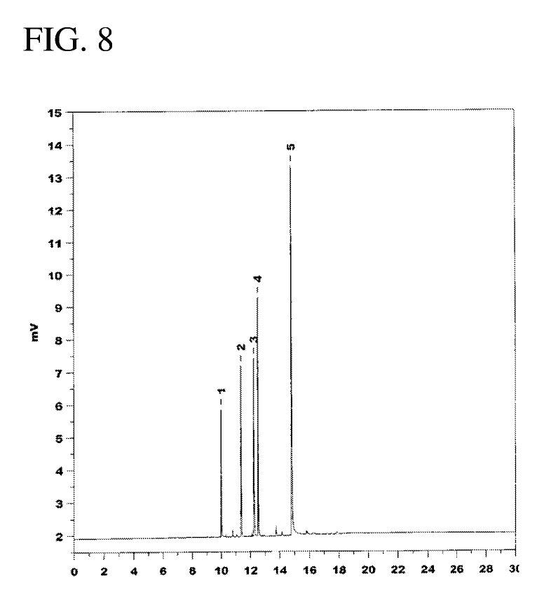

FIG. 8 represents CME-GC analysis of five underivatized chlorophenols extracted from an aqueous medium using a sol-gel poly-THF coated capillary. We did not have to use derivatization, pH adjustment or salting out effect to extract chlorophenols from aqueous medium. Still, we have achieved a lower detection limit (e.g., 18 ppt for pentachlorophenol, by CME-GC-FID) compared to other reports in the literature (1.4 ppb for the same compound, by SPME-GC-FID).

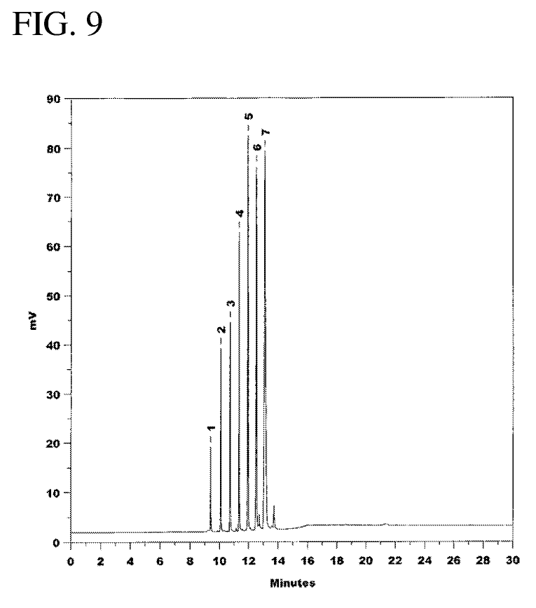

FIG. 9 represents a gas chromatogram for a mixture of alcohols. Being highly polar compounds, alcohols demonstrate higher affinity for water and are usually difficult to extract them from an aqueous matrix. In the present study, these highly polar analytes were extracted from aqueous samples using sol-gel poly-THF capillaries without exploiting any derivatization, pH adjustment or salting-out effects. The presented data indicate excellent affinity of the sol-gel poly-THF coating for these highly polar analytes that are often difficult to extract from aqueous media in underivatized form using commercial coatings. Moreover, high detection sensitivity (Table 3) and excellent symmetrical peak shapes also demonstrate outstanding performance of the sol-gel poly-THF coating and excellent deactivation characteristics of the sol-gel PEG column used for GC analysis, respectively.

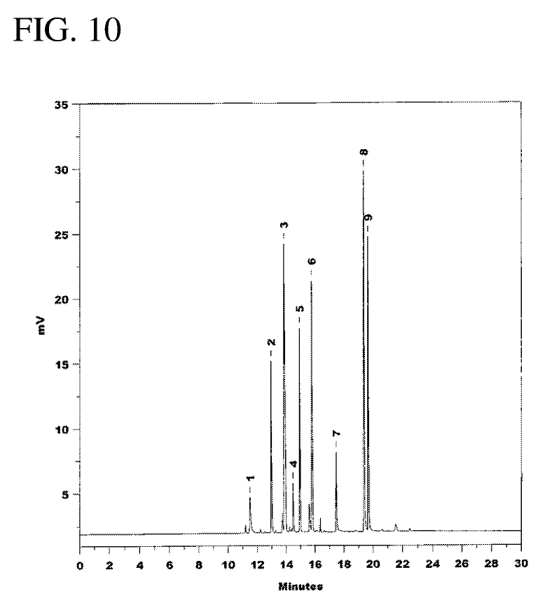

Finally, a mixture containing analytes from different chemical classes representing a wide polarity range was extracted from an aqueous sample using a sol-gel poly-THF coated capillary. As is revealed from the chromatogram (FIG. 10), a sol-gel poly-THF coated capillary can simultaneously extract nonpolar, moderately polar, and highly nonpolar compounds from an aqueous matrix. This may be explained by the existence of different polarity domains (organic and inorganic) in the sol-gel poly-THF coating.

Run-to-run repeatability and capillary-to-capillary reproducibility are two important characteristics for CME as a microextraction technique and for the sol-gel coating technique used for their preparation. These parameters were evaluated from experimental data involving replicate measurements carried out on the same capillary under the same set of conditions (run-to-run) or on a number of sol-gel coated capillaries prepared using the same protocol (capillary-to-capillary). The run-to-run repeatability and capillary-to-capillary reproducibility for sol-gel capillary microextraction were evaluated through peak area relative standard deviation (RSD) values for the extracted analytes. For nonpolar and moderately polar analytes (Table 2), these parameters had values in the range of 2.19-7.48% and 4.35-10.31, respectively. In the case of polar analytes (Table 3), these values were less than 7.4% and 11.8%, respectively. For a sample preparation technique, these peak area RSD values can be regarded as indicative of good consistency in CME performance of the microextraction capillaries as well as the good reproducibility in the method for their preparation. Moreover, the retention time (t_{R}) repeatability data for sol-gel PDMS and sol-gel PEG analysis columns are also indicative of the outstanding performance provided by sol-gel stationary phases used in GC analysis.

In the present work, sol-gel CME-GC operation was performed manually. Manual installation of the microextraction capillary in the GC system is a time-consuming operation. There are various possibilities to solve this problem, including the use of a robotic arm equipped with devices necessary for performing CME, desorbing the analytes, and transferring the desorbed analytes into the separation column.

Sol-gel capillary microextraction techniques as presently described have great potential for automated operation in hyphenation with both gas-phase and liquid-phase separation techniques. Because of the tubular format of the extraction device combined with high thermal and solvent stability of the surface-bonded sol-gel extraction coating, sol-gel capillary microextraction can be expected to offer high degree of versatility in automated operation.

An extensive variety of sol-gel compositions are possible. A sol-gel has the general formula:

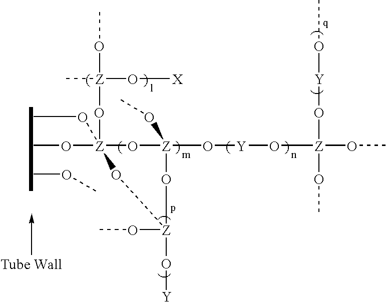

wherein,
X=Residual of a deactivation reagent (e.g., polymethylhydrosiloxane (PMHS), hexamethyldisilazane (HMDS), etc.);
Y=Sol-gel reaction residual of a sol-gel active organic molecule (e.g., hydroxy terminated molecules including polydimethylsiloxane (PDMS), polymethylphenylsiloxane (PMPS), polydimethyldiphenylsiloxane (PDMDPS), polyethylene glycol (PEG) and related polymers like Carbowax 20M, polyalkylene glycol such as Ucon, macrocyclic molecules like cyclodextrins, crown ethers, calixarenes, alkyl moieties like octadecyl, octyl, etc.
Z=Sol-gel precursor-forming chemical element (e.g. Si, Al, Ti, Zr, etc.)
I=An integer ≧0;
m=An integer ≧0;
n=An integer ≧0;
p=An integer ≧0;
q=An integer ≧0; and
l, m, n, p, and q are not simultaneously zero.

Dotted lines indicate the continuation of the chemical structure with X, Y, Z, or Hydrogen (H) in space.

The reagent system to produce sol-gels generally includes two sol-gel precursors, a deactivation reagent, one or more solvents and a catalyst. The sol-gel precursor contains a chromatographically active moiety selected from the group consisting of octadecyl, octyl, cyanopropyl, diol, biphenyl, phenyl, cyclodextrins, crown ethers and other moieties. Representative precursors include, but are not limited to: Methyltrimethoxysilane, Tetramethoxysilane, 3-(N-styrylmethyl-2-aminoethylamino)-propyltrimethoxysilane hydrochloride, N-tetradecyidimethyl(3-trimethoxysilylpropyl)ammonium chloride, N(3-trimethoxysilylpropyl)-N-methyl-N,N-diallylammonium chloride, N-trimethoxysilylpropyltri-N-butylammonium bromide, N-trimethoxysilylpropyl-N,N,N-trimethylammonium chloride, Trimethoxysilylpropylthiouronium chloride, 3-[2-N-benzyaminoethylaminopropyl]trimethoxysilane hydrochloride, 1,4-Bis(hydroxydimethylsilyl)benzene, Bis(2-hydroxyethyl)-3-aminopropyltriethoxysilane, 1,4-bis(trimethoxysilylethyl)benzene, 2-Cyanoethyltrimethoxysilane, 2-Cyanoethyltriethoxysilane, (Cyanomethylphenethyl)trimethoxysilane, (Cyanomethylphenethyl)triethoxysilane, 3-Cyanopropyidimethylmethoxysilane, 3-Cyanopropyltriethoxysilane, 3-Cyanopropyltrimethoxysilane, n-Octadecyltrimethoxysilane, n-Octadecyidimethylmethoxysilane, Methyl-n-Octadecyidiethoxysilane, Methyl-n-Octadecyidimethoxysilane, n-Octadecyltriethoxysilane, n-Dodecyltriethoxysilane, n-Dodecyltrimethoxysilane, n-Octyltriethyoxysilane, n-Octyltrimethoxysilane, n-Ocyidiisobutylmethoxysilane, n-Octylmethyidimethoxysilane, n-Hexyltriethoxysilane, n-isobutyltriethoxysilane, n-Propyltrimethoxysilane, Phenethyltrimethoxysilane, N-Phenylaminopropyltrimethoxysilane, Styrylethyltrimethoxysilane, 3-(2,2,6,6-tetramethylpiperidine-4-oxy)-propyltriethoxysilane, N-(3-triethoxysilylpropyl)acetyl-glycinamide, (3,3,3-trifluoropropyl)trimethoxysilane, and (3,3,3-trifluoropropyl)methyidimethoxysilane, and any other similar precursor known to those of skill in the art. Sol gel technology is taught in U.S. Pat. Nos. 6,759,126 B1 and 6,783,680 B2 and U.S. Patent Application Publication Nos. US 2002/0150923 A1, US 2003/0213732 A1, US 2004/0129141 A1 and US 2005/0106068 A1, the contents of which are incorporated herein by reference.

The deactivation reagent, hexamethyidisilazane (HMDS), and the sol-gel catalyst, Trifluoroacetic acid, were selected for the preparation of the columns of the instant invention, however, any deactivation reagent and/or catalyst as known to those of ordinary skill in the art may be used.

Sol-gel polytetrahydrofuran (poly-THF) coating was developed for high-sensitivity sample preconcentration by capillary microextraction (CME). Parts per quadrillion (ppq) level detection limits were achieved for both polar and nonpolar analytes through sample preconcentration on sol-gel poly-THF coated microextraction capillaries followed by gas chromatography (GC) analysis of the extracted compounds using a flame ionization detector (FID). The sol-gel coating was in situ created on the inner walls of a fused silica capillary using a sol solution containing poly-THF as an organic component, methyltrimethoxysilane (MTMOS) as a sol-gel precursor, trifluoroacetic acid (TFA, 5% water) as a sol-gel catalyst, and hexamethyidisilazane (HMDS) as a deactivating reagent. The sol solution was introduced into a hydrothermally-treated fused silica capillary and the sol-gel reactions were allowed to take place inside the capillary for 60 min. A wall-bonded coating was formed due to the condensation of silanol groups residing on the capillary inner surface with those on the sol-gel network fragments evolving in close vicinity of the capillary walls. Poly-THF is a medium polarity polymer, and was found to be effective in carrying out simultaneous extraction of both polar and nonpolar analytes. Efficient extraction of a wide range of trace analytes from aqueous samples was accomplished using sol-gel poly-THF coated fused silica capillaries for further analysis by GC. The test analytes included polycyclic aromatic hydrocarbons (PAHs), aldehydes, ketones, chlorophenols, and alcohols. Sol-gel poly-THF coated CME capillaries showed excellent solvent and thermal stability (>320 degrees C).

The invention will be further described by way of the following non-limiting example.

### EXAMPLE

### Development and Characterization of the Microextraction Capillary Having Surface-Bonded Sol-Gel Polytetrahydrofuran Coating

1. Equipment

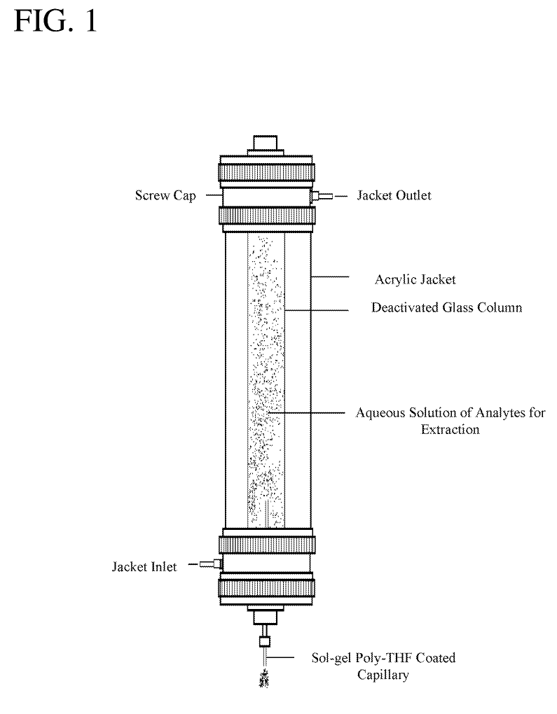

Capillary microextraction-gas chromatography (CME-GC) experiments with sol-gel poly-THF coated capillaries were carried out on a Shimadzu model 17A GC system (Shimadzu Corporation, Kyoto, Japan) equipped with a programmed temperature vaporizer (PTV injector) and a flame ionization detector (FID). An in-house designed liquid sample dispenser (FIG. 1) was used to perform CME via gravity-fed flow of the aqueous samples through the sol-gel poly-THF coated capillary. A Fisher Model G-560 Genie 2 Vortex (Fisher Scientific, Pittsburgh, Pa.) was used for thorough mixing of sol solution ingredients. A Microcentaur model APO 5760 microcentrifuge (Accurate Chemical and Scientific Corporation, Westbury, N.Y.) was used for centrifugation (at 13000 rpm, 15682 g) of sol solutions made for coating the microextraction capillaries. An Avatar model 320 FTIR System (Nicolet Analytical Instruments, Madison, Wis.) was used to obtain the IR spectra of poly-THF, sol-gel solution, and sol-gel poly-THF sorbent. AJEOL model JSM-35 scanning electron microscope was used for the investigation of the coated capillary surface. A homebuilt, gas pressure-operated filling/purging device was used to fill the extraction capillary with the sol solution, to expel the solution from the capillary after predetermined period of in-capillary residence, as well as to purge the microextraction capillary with helium. Ultra pure (17.2 MΩ) water was obtained from a Barnsted Model 04741 Nanopure deionized water system (Barnsted/Thermodyne, Dubuque, Iowa). ChromPerfect (Version 3.5 for Windows) computer software (Justice Laboratory Software, Denville, N.J.) was used for on-line collection, integration, and processing of the experimental data.

2. Chemicals and Materials

Fused silica capillary (250 μm i.d.) with a protective polyimide coating on the external surface was purchased from Polymicro Technologies Inc. (Phoenix, Ariz.). Poly-THF 250 was a gift from BASF Corporation (Parsippany, N.J.). Acenaphthene, fluorene, phenanthrene, fluoranthene, pyrene, n-nonanal, undecanal, dodecanal, tridecanal, valerophenone, hexanophenone, heptanophenone, decanophenone, 2,4-dichlorophenol, 2,4,6-trichlorophenol, 4-chloro, 3-methyl phenol, and pentachlorophenol were purchased from Aldrich Chemical Co. (Milwaukee, Wis.); n-decyl aldehyde, 1-nonanol, 1-decanol, 1-undecanol, and 1-tridecanol were purchased from Acros Organics (Pittsburgh, Pa.). Lauryl alcohol was purchased from Sigma Chemical Co. (St. Louis, Mo.). HPLC-grade methanol and methylene chloride and all borosilicate glass vials were purchased from Fisher Scientific (Pittsburgh, Pa.).

2.1 Preparation of Sol-Gel Poly-THF Coated Microextraction Capillaries

Sol-gel poly-THF coated microextraction capillaries were prepared by using a modified version of a previously described procedure. Briefly, a sol solution was prepared by dissolving 250 mg of Poly-THF 250, 250 μL of methyltrimethoxysilane (sol-gel precursor), 20 μL of 1,1,1,3,3,3-hexamethlyidisilazane (surface deactivation reagent), and 100 μL of trifluoroacetic acid (5% H₂O) (sol-gel catalyst) in 400 μL of methylene chloride. The mixture was then vortexed (3 min), centrifuged (5 min) and the clear supernatant of the sol solution was transferred to another clean vial. Following this, a piece of cleaned and hydrothermally treated fused silica capillary (5 m) was filled with the sol solution using a helium pressure-operated filling/purging device. The sol solution was kept inside the capillary for 60 min to facilitate the formation of a surface-bonded sol-gel coating. On completion of the in-capillary residence time, the unbonded portion of the sol solution was expelled from the capillary under helium pressure (50 psi) and the coated capillary was purged with helium for an hour. The sol-gel poly-THF coated capillary was further conditioned in a GC oven using temperature-programmed heating (from 40° C. to 320° C. @ 1° C. /min, held at 320° C. for 5 hours under helium purge). Before using for extraction, the sol-gel poly-THF coated capillary was rinsed sequentially with methylene chloride and methanol followed by drying in a stream of helium under the same temperature-programmed conditions as above, except that the capillary was held at the final temperature for 30 min. The sol-gel poly-THF coated capillary was then cut into 12.5 cm long pieces that were further used to perform microextraction.

2.2 Preparation of Sol-Gel PDMS and Sol-Gel PEG Columns for GC Analysis

The GC capillary columns used to analyze the extracted compounds were also prepared in-house by sol-gel technique. For nonpolar and moderately polar analytes, a sol-gel PDMS column was used. For polar analytes, a sol-gel PEG capillary column was employed. The sol-gel PDMS and sol-gel PEG columns were prepared by procedures described by Wang et al. and Shende et al., respectively.

2.3 Cleaning and Deactivation of Glassware

To avoid any contamination of the standard solutions from the glassware, all glassware used in the current study was thoroughly cleaned with Sparkleen detergent followed by rinsing with copious amount of deionized water and drying at 150° C. for 2 hours. To silanize the inner surface of the dried glassware, they were treated with a 5% v/v solution of HMDS in methylene chloride followed by heating in an oven at 250° C. for 8 hours under helium purge. The silanized glassware was then rinsed sequentially with methylene chloride and methanol and dried in an oven at 100° C. for 1 hour. Prior to use, all glassware were rinsed with generous amounts of deionized water and dried at room temperature in a flow of helium.

2.4 Preparation of Standard Solutions for CME on Sol-Gel Poly-THF Coated Capillaries.

All stock solutions were prepared by dissolving 50 mg of each analyte in 5 mL of methanol in a deactivated amber glass vial (10 mL) to obtain a solution of 10 mg/mL. The solution was further diluted to 0.1 mg/mL in methanol. The final aqueous solution was prepared by further diluting this solution with water to achieve μg/mL to ng/mL level concentrations depending on the compound class. Freshly prepared aqueous solutions were used for extraction.

2.5 Gravity-Fed Sample Dispenser for Capillary Microextraction

A gravity-fed sample dispenser was used for capillary microextraction (FIG. 1). It was built by modifying a Chromaflex AQ column (Kontes Glass Co., Vineland, N.J.), which consists of a thick-walled Pyrex glass cylinder concentrically placed in an acrylic jacket. Since glass surfaces tend to adsorb polar analytes, the inner surface of the glass cylinder was deactivated by treating with HMDS solution as described before. The cylinder was then cooled down to ambient temperature, thoroughly rinsed with methanol and deionized water, and dried in a helium gas flow. The system was then reassembled.

2.6 Extraction of Analytes on Sol-Gel Poly-THF Coated Capillaries

A 12.5 cm long segment of the sol-gel poly-THF coated capillary (250 μm i.d.) was conditioned under helium purge in a GC oven using a temperature program (from 40° C. to 320° C. @ 10° C./min, held at the final temperature for 30 min). The conditioned capillary was then vertically connected to the lower end of the gravity-fed sample dispenser (FIG. 1) using a plastic connector. A 50 mL volume of the aqueous sample containing trace concentrations of the target analytes was added to the inner glass cylinder through the sample inlet located at the top of the dispenser. The solution was passed through the capillary for 30 min to facilitate the extraction equilibrium to be established. The capillary was then detached from the dispenser and purged with helium for 1 min to remove residual water from the capillary walls.

2.7 Thermal Desorption of Extracted Analytes and CME-GC Analysis

For GC analysis, the sol-gel poly-THF coated capillary containing the extracted analytes was installed in the GC injection port and interfaced with the GC capillary column. Before carrying out the installation, both the injection port and the GC oven were cooled down to 30° C. and the glass wool was removed from the injection port liner. One end of the capillary was then introduced into the glass liner from the bottom end of the injection port so that -8 cm of the capillary remained inside the injection port. A graphite ferrule was used to secure an airtight connection between the capillary and the injection port. Interfacing of the extraction capillary with the GC column was accomplished by using a deactivated two-way press-fit quartz connector. Installation and interfacing of the extraction capillary with the GC column were followed by thermal desorption of extracted analytes from the installed sol-gel poly-THF coated microextraction capillary. For this, the temperature of the PTV injection port was rapidly raised to 300° C. @ 100° C. /min while keeping the GC oven temperature at 30° C. (5 min). Under these temperature program conditions, the extracted analytes were effectively desorbed from the sol-gel poly-THF coating and were transported to the cooler coupling zone consisting of the lower end segment of the microextraction capillary and/or to the front end of the GC column—both located inside the GC oven and maintained at 30° C. As the desorbed analytes reached the cooler interface zone (30° C.), they were focused into a narrow band. On completion of the 5-min desorption and focusing period, the analytes in this narrow band were analyzed by GC using temperature-programmed operation as follows: from 30° C. to 300° C. @ 20° C. /min with a 10 min hold time at the final temperature.

### REFERENCES

Amdur, M. O., In M. O. Amdur, J. Doull, and C. D. Klaassen (Eds.), Air Pollutanta. In Casarett and Doull's Toxicology: The basic Science of Poisons. 4^{th} ed., Pergamon Press, New York, 1991, Chapter 25, p. 866.
Arthur, C. L. and J. Pawliszyn, Anal. Chem. 62 (1990) 2145.
Arthur, C. L., L. M. Killam, K. D. Buchholz, J. Pawliszyn, and J. R. Berg, Anal. Chem. 64 (1992)1960.
Bao, M.-L., F. Pantani, O. Griffini, D. Burrini, D. Santianni, and K. Barbieri, J. Chromatogr. A 809 (1998) 75.
Betrabet, C. S. and G. L. Wilkes, Chem. Mater. 7 (1995) 535.
Bigham, S., J. Medlar, A. Kabir, C. Shende, A. Alli, and A. Malik, Anal. Chem. 74 (2002) 752.
Blomberg, L. G. J. Microcolumn Sep. 2 (1990) 62.
Brennan, A. B., and G. L. Wilkes, Polymer 32 (1991) 733.
Brinker, C. J. and G. W. Scherer. Sol-gel Science. The Physics and Chemistry of Sol-gel Processing. Academic Press, San Diego, Calif., 1990.
Buchholz, K. D. and J. Pawliszyn, Anal. Chem. 66 (1994) 160.
Byorseth, A., and T. Ramdahl, (Eds.), Handbook of Polycyclic Aromatic Hydrocarbons. Vol. 2, Emission, Sources, and Recent Progress in Analytical Chemistry. Marcel Dekker, New York, Basel, 1985, p. 1.
Cancho, B., F. Ventura and M. T. Galceran, J. Chromatogr. A 943 (2002) 1.
Cataldo, F, Eur. Polym. J. 32 (1996) 1297.
Chong, D.-X. Wang, S.-L., J. D. Hayes, B. W. Wilhite, and A. Malik, Anal. Chem. 69 (1997) 3889.
Chong, S. L., M. S. Thesis, University of South Florida, 1997.
Doong, R. A., S. M. Chang, and Y. C. Sun, J. Chromatogr. A 879 (2000)177.
Dreyfuss, P., M. P. Dreyfuss, and G. Pruckmayr, Encyclopedia of Polymer Science and Engineering. Wiley, N.Y., 16 (1989) 649.
Eisert, R. and J. Pawliszyn, Anal. Chem. 69 (1997) 3140.
EPA 822-Z-99-001, U.S. Environmental Protection Agency, Office of Water, Washington, D.C., 1999.
Fidalgo, A. and L. Ilharco, J. Sol-Gel Sci. Technol. 13 (1998) 433.
Fidalgo, A. and L. M. llharco, J. Non-Crystalline Solids 283 (2001) 144.
Fidalgo, A., T. G. Nunes and L. M. llharco, J. Sol-Gel Sci. Technol. 19 (2000) 403.
Gbatu, T. P., K. L. Sutton and J. A. Caruso, Analytica Chimica Acta 402 (1999) 67.
Goda, H. and C. W. Frank, Chem. Mater. 13 (2001) 2783.
Hageman, K. J., L. Mazeas, C. B. Grabanski, D. J. Miller, and S. B. Hawthorne, Anal. Chem. 68 (1996) 3892.
Hall, B. J. and J. S. Brodbelt, J. Chromatogr. A 777 (1997) 275.
Hayes, J. D., and A. Malik, J. Chromatogr. B 695 (1997) 3.
Higuchi, T., K. Kurumada, S. Nagamine, A. W. Lothongkum and M. Tanigaki, J. Materials Science 35 (2000) 3237.
Honma, I, O. Nishikawa, T. Sugimoto, S. Nomura and H. Nakajima, Fuel Cells 2 (2002) 52.
Kamitakahara, M., M. Kawashita, N. Miyata, T. Kokubo and T. Nakamura, Biomaterials 24 (2003) 1357.
Kataoka, H. and K. Mitani, Jan. J. Forensic Toxicol. 20 (2002) 251.
Kieber, R. J., and K. Mopper, Environ. Sci. Technol. 24 (1990) 1477.
Kitunen, V. H., R. J. Valo, and M. S. Salkainoja-Salonen, Environ. Sci. Technol. 21 (1987) 96.
Klein, L. C. Sol-gel Technology for Thin Films, Fibers, Preforms, Electronics, and Specialty Shapes. Noyes Publications, Park Ridge, N.J., 1988.
Lee, H. S. and J. Hong, J. Chromatogr. A 868 (2000) 189.
Lee, M.-R., Y.-C. Yeh, W.-S. Hsiang and B.-H. Hwan, J. Chromatogr. A 806 (1998) 317.
Livage, J., In J. F. Harrod, and R. M. Laine (Eds.), Applications of Organometallic Chemistry in the Preparation and Processing of Advanced Materials. Kluwer, Dordrecht, The Netherlands, 1995, p. 3.

Louch, D., S. Motlagh, and J. Pawliszyn, Anal. Chem. 64 (1992) 1187.
Malik, A., S.-L. Chong and In J. Pawliszyn (Ed.), Applications of Solid-phase Microextraction. Royal Society of Chemistry (RSC), Cambridge (UK), 1999, 73.
Man i, V. and In: J. Pawliszyn (Ed.), Applications of Solid-phase Microextraction. Royal Society of Chemistry (RSC), Cambridge (UK), 1999, p. 57.
Manufacturer data sheet. Supelco corp., Bellefonte, Pa., 2003, p. 360.
Mills, O. E. and A. J. Broome, ACS Symp. Ser. 705 (1998) 85.
Moder, M., S. Schrader, U. Frank and P. Popp, Fresenius J. Anal. Chem. 357 (1997) 326.
National Research Council. Formaldehyde and other Aldehydes: Board on Toxicology and Environmental Health Hazards. National Academy Press, Washington DC, 1981.
Nawrocki, J., I. Kalkowska and A. Dabrowska, J. Chromatogr. A 749 (1996) 157.
Novak, B. M., Adv. Mater. 5 (1993) 422.
Office of the Federal Registration (OFR), Appendix A: priority pollutants, Fed Reg. 47 (1982) 52309.
Pawliszyn, J. Solid-Phase Microextraction. Theory and Practice, Wiley, N.Y., 1997.
Potter, D. W. and J. Pawliszyn, Environ. Sci. Technol. 28 (1994) 298.
Puig, D. and D. Barcelo, Trends Anal. Chem. 15 (1996) 362.
Puma, G. L. and P. L. Yue, Ind. Eng. Chem. Res. 38 (1999) 3238.
Shende, C., A. Kabir, E. Townsend, and A. Malik, Anal. Chem., 75 (2003) 3518.
Stashenko, E. E., M. A. Puertas and J. R. Martinez, Anal. Bioanal. Chem. 373 (2002) 70.
U.S. Congress. Compilation of Acts within the jurisdiction of the Committee on Energy and Commerce. U.S. Government Printing Office, Washington DC, 1991.
Wang, D.-X., S.-L. Chong, A. Malik, Anal. Chem. 69 (1997) 4566.
Wang, Z., C. Xiao, C. Wu, and H. Han, J. Chromatogr. A 893 (2000) 157.
Wegman, R. C. C., and A. W. M. Hofstee, Water Res. 13 (1979) 651.
Wu, J. and J. Pawliszyn, J. Chromatogr. A 909 (2001) 37.
Yang, M., Z. R. Zeng, W. L. Qiu and Y. L. Wang, Chromatographia 56 (2002) 73.
Yu, J., L. Dong, C. Wu, L. Wu and J. Xing, J. Chromatogr. A 978 (2002) 37.
Zhou, Z. P., Z. Y. Wang, C. Y. Wu, W. Zhan and Y. Xu, Anal. Letters 32 (1999) 1675.
Zeng, Z., W. Qiu and Z. Huang, Anal. Chem. 73 (2001) 2429.
Zeng, Z., W. Qiu, M. Yang, X. Wei, Z. Huang and F. Li, J. Chromatogr. A 934 (2001) 51.

What is claimed is:

1. A method of making a sol-gel polytetrahydrofuran-based coating comprising the steps of:
mixing two or more suitable sol-gel precursors to form a sol-gel solution wherein a first of the two or more sol-gel precursors is polytetrahydrofuran;
hydrolyzing the sol-gel solution to form hydrolyzed products;
polycondensating the hydrolyzed products to form a sol-gel network wherein the sol-gel network forms an evolving organic-inorganic network; and
surface bonding the sol-gel network to a substrate to form a surface bonded sol-gel coating thereon.

2. The method according to claim 1 wherein a second of the two or more sol-gel precursors is methyltrimethoxysilane.

3. The method according to claim 1 further comprising the step of deactiviating residual silanol groups on the sol-gel coating with a deactivating agent.

4. The method of claim 3 wherein the deactivating reagent is selected from the group consisting of hydrosilanes, polymethylhydrosiloxianes, polymethylphenyl hydrosiloxanes and polymethylcyanopropyl hydrosiloxanes.

5. The method of claim 3 wherein the deactivating reagent is hexamethyidisilazane.

6. The method according to claim 3, wherein said deactivating step occurs at elevated temperatures during column conditioning.

7. The method according to claim 1 wherein the mixing step further includes adding trifluoroacetic acid as a catalyst.

8. The method according to claim 7, wherein said mixing step further includes adding an additional catalyst selected from the group consisting of acids, bases and fluorides.

9. The method according to claim 1 wherein the hydrolyzing and polycondensating steps occur within the inner walls of a capillary tube wherein the capillary tube forms the coated substrate.

10. A microextraction capillary for the preconcentration of trace analytes in a sample the microextraction capillary having a tube structure and an inner surface the inner surface further comprising a sol-gel polytetrahydrofuran-based coating wherein the sol-gel polytetrahydrofuran-based coating forms the stationary phase for the microextraction of the analytes.

11. The microextraction capillary of claim 10 wherein said sol-gel polytetrahydrofuran-based coating is made from two or more sol-gel precursors wherein a first of the two or more sol-gel precursors is polytetrahydrofuran.

12. The microextraction capillary of claim 10 wherein a second of the two or more sol-gel precursors is methyltrimethoxysilane.

13. The microextraction capillary of claim 10 wherein the inner surface is a fused silica inner surface.

14. The microextraction capillary of claim 13 wherein the sol-gel polytetrahydrofuran-based coating is chemically bonded to the fused-silica inner surface of the capillary.

15. The microextraction capillary of claim 10 having an outer surface the outer surface comprising a protective coating to prevent against breakage of the capillary.

16. The microextraction capillary of claim 15 wherein the protective coating is polyimide.

17. The microextraction capillary of claim 10 wherein the sol-gel polytetrahydrofuran-based coating is at least about 250 μm in thickness.

18. A method of making a polytetrahydrofuran-based sol-gel coated capillary for microextraction of analytes in a sample medium comprising the steps of:
preparing a sol solution comprising polytetrahyrdofuran (poly-THF);
processing the sol solution to form a sol-gel extraction medium;
filling a capillary with the sol-gel extraction medium wherein the sol-gel extraction medium chemically binds to the inner walls of the capillary to form a polytetrahydrofuran-based sol-gel coated capillary; and
purging the capillary of unbound sol-gel extraction medium.

19. The method of claim 18 wherein the sol solution further comprises methyltrimethoxysilane as a sol-gel precursor.

20. The method of claim 18 wherein the capillary remains filled with the sol-gel extraction media for at least about 30 minutes to facilitate the formation of a surface bonded sol-gel coating before the unbound sol-gel extraction medium is purged.

21. The method of claim 18 wherein the capillary remains filled with the sol-gel extraction media for about 60 minutes to facilitate the formation of a surface bonded sol-gel coating before the unbound sol-gel extraction medium is purged.

22. The method of claim 18 wherein the step of purging the capillary of unbound sol-gel extraction medium is performed by applying helium pressure of about 50 psi for at least about 30 minutes.

23. The method of claim 18 further comprising the step of conditioning the polytetrahydrofuran-based sol-gel coated capillary in an oven using temperature-programmed heating wherein the heat increments upward from about 40° C. to about 320° C. at an increment of about 1° C./minute followed by a holding at about 320° C. for about 5 hours.
